(19) United States
(12) Patent Application Publication
(10) Pub. No.: US 2024/0293209 A1
(43) Pub. Date: Sep. 5, 2024

(54) ORAL IRRIGATOR EASILY DISASSEMBLED AND ASSEMBLED

(71) Applicant: RISUN TECHNOLOGY (SHENZHEN) LIMITED, Shenzhen (CN)

(72) Inventors: Qingxin LIU, Shenzhen (CN); Xiangwen WANG, Shenzhen (CN); Dongbao LI, Shenzhen (CN)

(73) Assignee: RISUN TECHNOLOGY (SHENZHEN) LIMITED, Shenzhen (CN)

(21) Appl. No.: 18/664,826

(22) Filed: May 15, 2024

Related U.S. Application Data
(63) Continuation of application No. PCT/CN2023/130549, filed on Nov. 8, 2023.

(30) Foreign Application Priority Data
Feb. 15, 2023 (CN) 202310151882.0

(51) Int. Cl. A61C 17/02; A61C 17/028

(52) U.S. Cl. CPC A61C 17/0202; A61C 17/028; A61C 2204/002

(57) ABSTRACT

Disclosed is an oral irrigator easily disassembled and assembled, and the oral irrigator includes: an oral irrigator nozzle, an oral irrigator upper cover, an oral irrigator inner shell, an oral irrigator main shell and an oral irrigator bottom cover. One end of the oral irrigator main shell is provided with the oral irrigator inner shell and the oral irrigator upper cover in sequence, and the other end of the oral irrigator main shell is detachably connected to the oral irrigator bottom cover. The oral irrigator main shell is provided with a first accommodating cavity and a second accommodating cavity in sequence, and the first accommodating cavity and the second accommodating cavity are separated by a charging base; a water pump mechanism is provided in the first accommodating cavity, and the second accommodating cavity is configured to store water. The oral irrigator inner shell is provided with a locking assembly.

### CROSS-REFERENCE TO RELATED APPLICATIONS

The present application is a continuation application of International Application No. PCT/CN2023/130549, filed on Nov. 8, 2023, which claims priority to Chinese Patent Application No. 202310151882.0, filed on Feb. 15, 2023. The disclosures of the above-mentioned applications are incorporated herein by reference in their entireties.

### TECHNICAL FIELD

The present application relates to the technical field of disassembly and assembly of oral irrigators, and in particular to an oral irrigator easily disassembled and assembled.

### BACKGROUND

An oral irrigator is a structure configured to care for the oral cavity. The oral irrigator uses a certain pressure to spray the cleaning water column from the nozzle of the oral irrigator to clean the user's oral cavity. The oral irrigators are currently widely used in people's daily lives.

In the related art, Chinese Patent Application Publication No. CN115227425A discloses an oral irrigator, which includes an upper shell, a middle shell, a bottom shell, a machine core structure and a nozzle. A water tank structure is installed on one side of the middle shell. The water tank structure includes a water tank shell slidingly snapped with the middle shell. The bottom of the water tank shell is provided with a water tank bottom plate. The outer wall of the water tank shell is provided with a water inlet, and a water tank door for closing the water inlet is hinged on the water tank bottom plate. The machine core structure is connected to the water tank shell by a pipeline. The nozzle is connected to the machine core structure by an installation structure. The upper shell of the oral irrigator, middle shell of the oral irrigator and water tank of the oral irrigator are separate structures, which results in a lot of installation structures of the oral irrigator, and the installation method is relatively complicated, thereby increasing the overall manufacturing cost of the oral irrigator.

Therefore, how to provide an oral irrigator easily disassembled and assembled to facilitate the disassembly and assembly of oral irrigators and reduce manufacturing costs has become an urgent technical problem to be solved.

### SUMMARY

The technical problem to be solved by the present application is how to provide an oral irrigator easily disassembled and assembled to facilitate the disassembly and assembly of oral irrigators and reduce manufacturing costs.

To this end, according to the first aspect, an embodiment of the present application discloses an oral irrigator easily disassembled and assembled, including: an oral irrigator nozzle, an oral irrigator upper cover, an oral irrigator inner shell, an oral irrigator main shell and an oral irrigator bottom cover. One end of the oral irrigator main shell is provided with the oral irrigator inner shell and the oral irrigator upper cover in sequence, and the other end of the oral irrigator main shell is detachably connected to the oral irrigator bottom cover. The oral irrigator main shell is provided with a first accommodating cavity and a second accommodating cavity in sequence, and the first accommodating cavity and the second accommodating cavity are separated by a charging base; a water pump mechanism is provided in the first accommodating cavity, and the second accommodating cavity is configured to store water. The oral irrigator inner shell is provided with a locking assembly for locking and installing the oral irrigator nozzle. The water pump mechanism is configured to extract water in the second accommodating cavity and spray extracted water from the oral irrigator nozzle to clean teeth.

In an embodiment, a storage rack is provided in the charging base, and the storage rack is provided with a storage slot for snapping and storing the oral irrigator nozzle.

In an embodiment, the oral irrigator bottom cover is sleeved with a first waterproof ring.

In an embodiment, the oral irrigator bottom cover is provided with a toggle bump, and the toggle bump is configured to facilitate disassembly and assembly of the oral irrigator bottom cover.

In an embodiment, the oral irrigator main shell is provided with a water inlet communicated with the second accommodating cavity, the water inlet is provided with a water tank door for closing the water inlet, and the water tank door is sleeved and connected with a second waterproof ring.

In an embodiment, the locking assembly includes an installation seat, a locking element and a release button, one end of the oral irrigator nozzle is configured to pass through the oral irrigator upper cover and is embedded in the installation seat, the release button is embedded in the oral irrigator upper cover, the locking element is configured to pass through the installation seat and snap with the oral irrigator nozzle, and the release button is configured to drive the locking element to move horizontally to separate the locking element from the oral irrigator nozzle.

In an embodiment, the locking member is provided with a locking column, the locking column is sleeved and connected with a locking spring, and one end of the locking spring is abutted against the installation seat.

In an embodiment, the oral irrigator upper cover is detachably connected with an installation platform, a reset spring is provided in the installation platform, and the reset spring is abutted against the release button.

In an embodiment, the water pump mechanism includes a first installation rack and a second installation rack detachably connected to the first installation rack; an oral irrigator water pump, an oral irrigator motor and a battery are provided between the first installation rack and the second installation rack; a water inlet end of the oral irrigator water pump is connected to the charging base by a pipeline, a water outlet end of the oral irrigator water pump is communicated with the oral irrigator nozzle, and the oral irrigator motor is configured to drive the oral irrigator water pump to perform pumping work.

In an embodiment, a control panel for controlling a working status of the oral irrigator is provided on the second installation rack, the control panel is provided with a display light and a digital display tube, and the display light is configured to display a working gear of the oral irrigator.

The present application has the following beneficial effects: by providing the first accommodating cavity and the second accommodating cavity in the oral irrigator main shell in sequence, the first accommodating cavity is provided with the water pump mechanism, and the second accommodating cavity is configured to store water, thereby providing an oral irrigator easily disassembled and assembled, and facilitating disassembly and assembly of the oral irrigator. Since the oral irrigator main shell and the water tank shell are an integrally formed structure, the manufacturing cost of the oral irrigator is reduced.

### BRIEF DESCRIPTION OF THE DRAWINGS

In order to explain the embodiments of the present application or the technical solutions in the related art more clearly, the accompanying drawings needed to be used in the description of the embodiments or the related art will be briefly introduced below. Obviously, the accompanying drawings in the following description are only some embodiments of the present application, and other accompanying drawings can be obtained based on these accompanying drawings without creative efforts for those of ordinary skill in the art.

FIG. 1 is a first three-dimensional schematic structural view of an oral irrigator easily disassembled and assembled disclosed in the embodiments of the present application.

FIG. 2 is a second three-dimensional schematic structural view of an oral irrigator easily disassembled and assembled disclosed in the embodiments of the present application.

FIG. 3 is a schematic exploded structural view of an oral irrigator easily disassembled and assembled disclosed in the embodiments of the present application.

FIG. 4 is a schematic structural view of a locking assembly in an oral irrigator easily disassembled and assembled disclosed in the embodiments of the present application.

FIG. 5 is a schematic exploded structural view in a locking assembly of an oral irrigator easily disassembled and assembled disclosed in the embodiments of the present application.

FIG. 6 is a schematic structural view of a locking element in an oral irrigator easily disassembled and assembled disclosed in the embodiments of the present application.

FIG. 7 is a schematic structural view of a release button in an oral irrigator easily disassembled and assembled disclosed in the embodiments of the present application.

FIG. 8 is a schematic structural view of a water pump mechanism in an oral irrigator easily disassembled and assembled disclosed in the embodiments of the present application.

FIG. 9 is a partial cross-sectional schematic structural view of an oral irrigator easily disassembled and assembled disclosed in the embodiments of the present application.

FIG. 10 is a schematic structural view of an oral irrigator main shell in an oral irrigator easily disassembled and assembled disclosed in the embodiments of the present application.

### DETAILED DESCRIPTION OF THE EMBODIMENTS

In order to make the purpose, technical solutions and advantages of the present application more clear, the present application will be further described in detail below in conjunction with the accompanying drawings and embodiments. It should be understood that the specific embodiments described here are only configured to explain the present application and are not used to limit the present application.

In the description of the present application, it should be noted that, unless otherwise clearly stated and limited, the terms “install”, “join” and “connect” should be understood in a broad sense. For example, it can be a fixed connection, a detachable connection or an integral connection; it can be a mechanical connection or an electrical connection; it can be a direct connection or an indirect connection through an intermediate medium; it can be an internal connection between two components, or the interaction between two components; it can be a wireless connection or a wired connection connect. For those of ordinary skill in the art, the specific meanings of the above terms in the present application can be understood on a case-by-case basis.

In the description of the present application, it should be noted that, the orientation or positional relationships indicated by the terms “center”, “up”, “down”, “left”, “right”, “vertical”, “horizontal”, “inside”, “outside”, etc. are based on the orientation or positional relationship shown in the accompanying drawings, which are merely for convenience of describing the present application and simplifying the description, and do not indicate or imply that the devices or elements referred to must have a specific orientation or must be constructed and operated in a specific orientation, therefore, it cannot be construed as a limitation on the present application. Furthermore, the terms “first”, “second” and “third” are used for descriptive purposes only and are not to be construed as indicating or implying relative importance.

In addition, the technical features involved in different embodiments of the present application described below can be combined with each other as long as they do not conflict with each other.

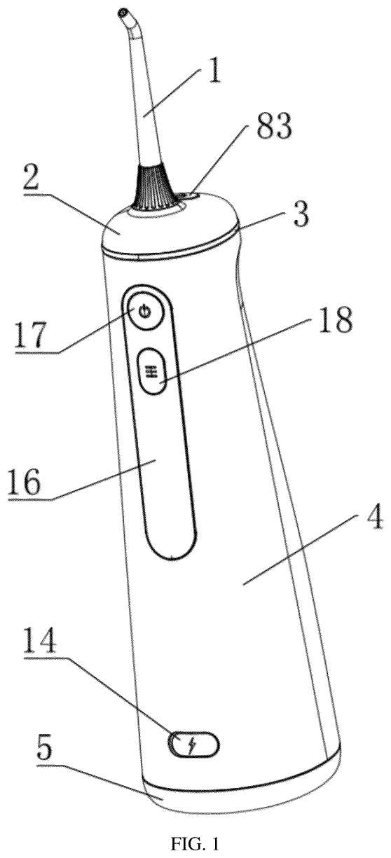

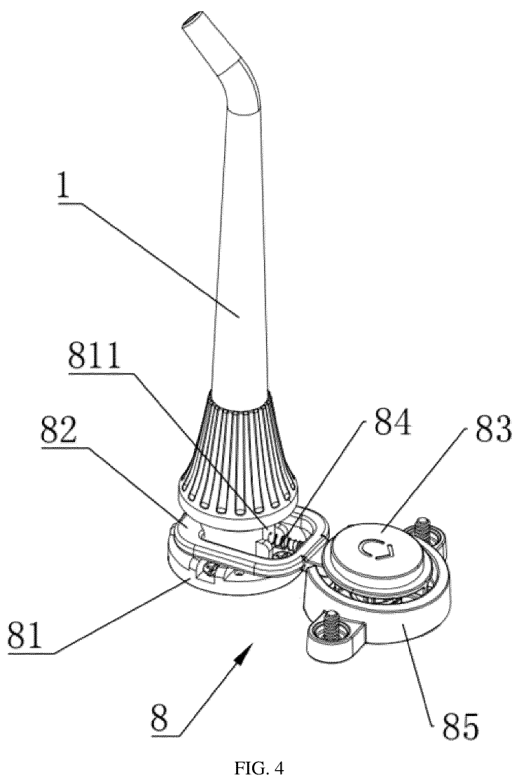

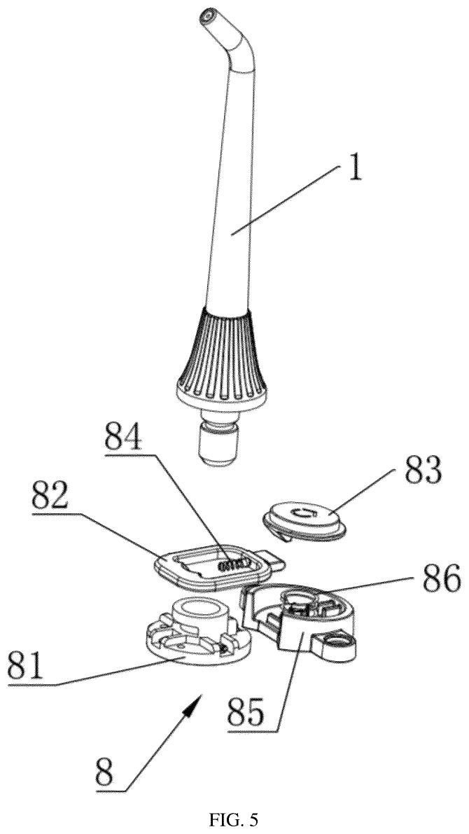

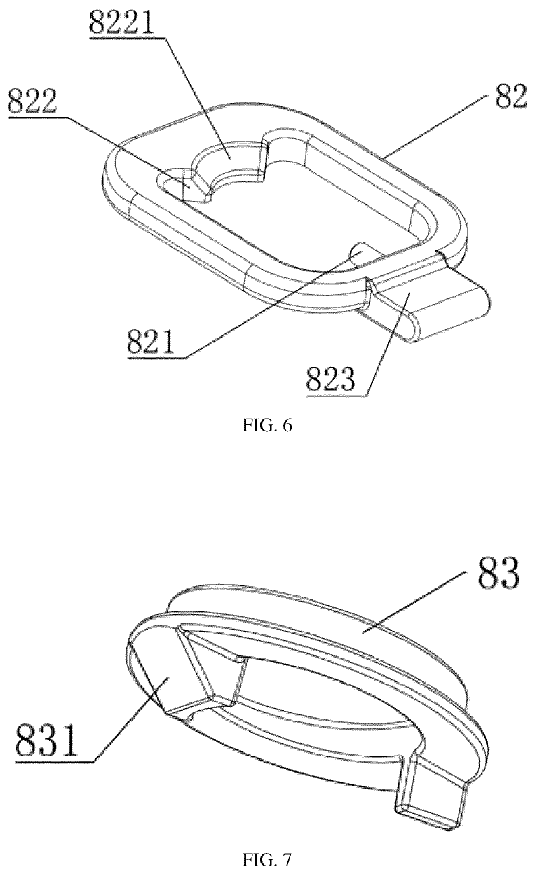

The embodiment of the present application discloses an oral irrigator easily disassembled and assembled, as shown in FIG. 1 to FIG. 10, including: an oral irrigator nozzle 1, an oral irrigator upper cover 2, an oral irrigator inner shell 3, an oral irrigator main shell 4 and an oral irrigator bottom cover 5. One end of the oral irrigator main shell 4 is provided with the oral irrigator inner shell 3 and the oral irrigator upper cover 2 in sequence, and the other end of the oral irrigator main shell 4 is detachably connected to the oral irrigator bottom cover 5. The oral irrigator main shell 4 is provided with a first accommodating cavity 41 and a second accommodating cavity 42 in sequence, and the first accommodating cavity 41 and the second accommodating cavity 42 are separated by a charging base 6. A water pump mechanism 7 is provided in the first accommodating cavity 41, and the second accommodating cavity 42 is configured for storing water. The oral irrigator inner shell 3 is provided with a locking assembly 8 for locking and installing the oral irrigator nozzle 1. The water pump mechanism 7 is configured to extract water in the second accommodating cavity 42 and spray extracted water from the oral irrigator nozzle 1 to clean teeth. In the specific implementation process, in order to prevent negative pressure from being generated in the second accommodating cavity 42, the oral irrigator main shell 4 is provided with a pressure relief hole 44 communicated with the second accommodating cavity 42, and a notch 45 for draining the water inside the oral irrigator.

It should be noted that by providing the first accommodating cavity 41 and the second accommodating cavity 42 in the oral irrigator main shell 4 in sequence, the first accommodating cavity 41 is provided with the water pump mechanism 7, and the second accommodating cavity 42 is configured to store water, thereby providing an oral irrigator easily disassembled and assembled, and facilitating disassembly and assembly of the oral irrigator. Since the oral irrigator main shell 4 and the water tank shell are an integrally formed structure, the manufacturing cost of the oral irrigator is reduced.

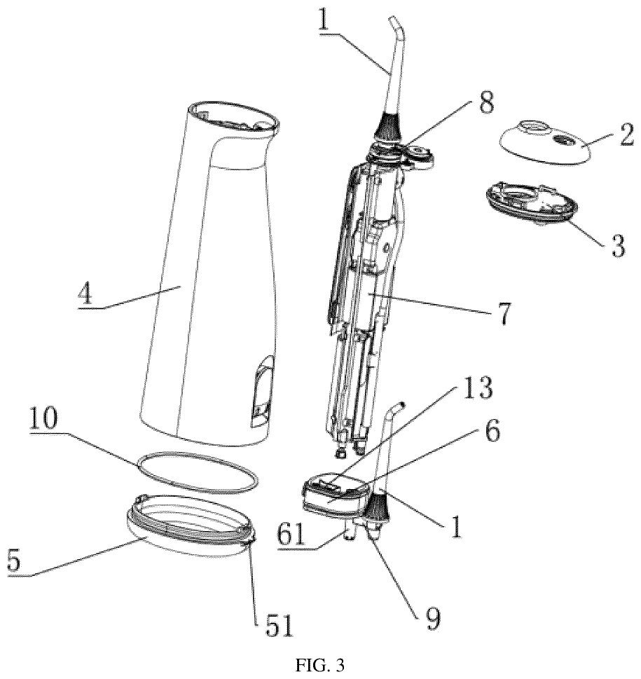

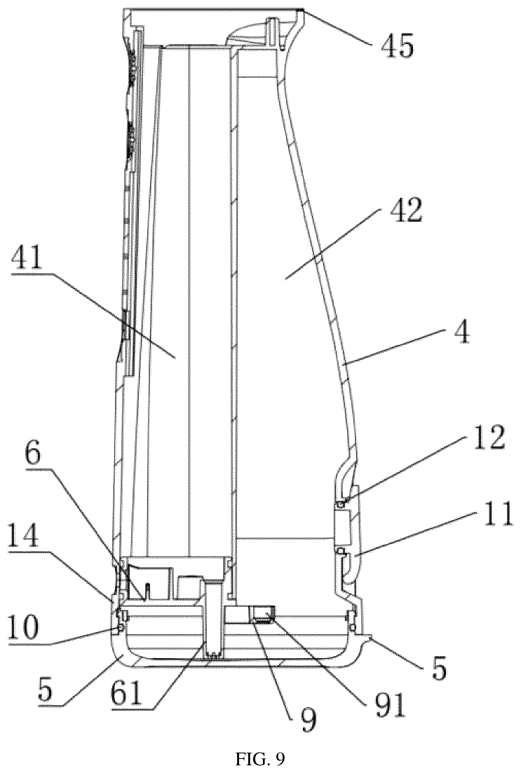

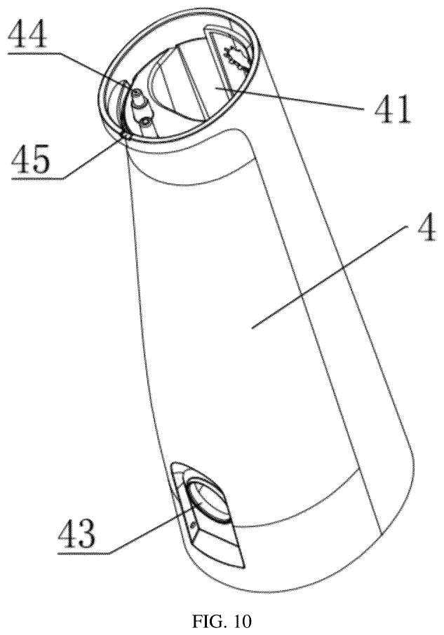

As shown in FIG. 3 and FIG. 9, a storage rack 9 is provided in the charging base 6, and the storage rack 9 is provided with a storage slot 91 for snapping and storing the oral irrigator nozzle 1. In the specific implementation process, the charging base 6 is provided with a direct current (DC) charger 13 for charging the oral irrigator, the oral irrigator main shell 4 is provided with a charging port 46, and the charging port 46 is closed by the charging cover 14 provided on the oral irrigator main shell 4. The charging base 6 is provided with a water inlet pipe 61 for communicating with the water pump mechanism 7. The storage rack 9 is provided on the side wall of the water inlet pipe 61. The charging base 6, the water inlet pipe 61 and the storage rack 9 are an integrally formed structure, and the storage slot 91 is provided in an arc shape.

As shown in FIG. 1 to FIG. 3, the oral irrigator bottom cover 5 is sleeved with a first waterproof ring 10. In the specific implementation process, the first waterproof ring 10 is provided in an O shape, and the first waterproof ring 10 is made of rubber or silicone material.

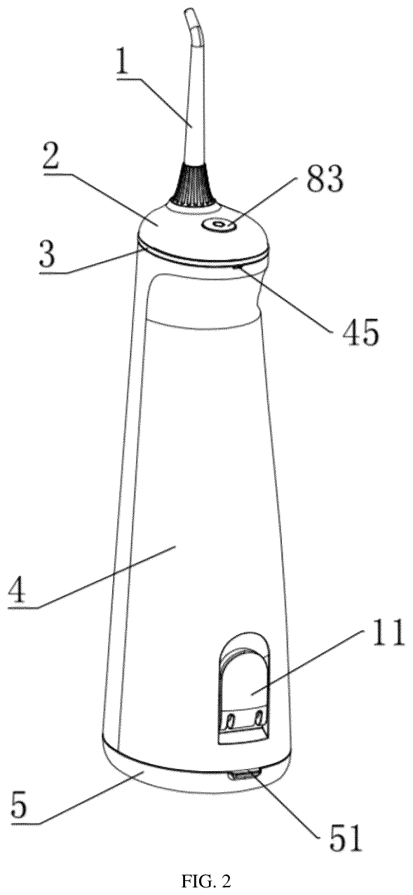

As shown in FIG. 2 and FIG. 3, the oral irrigator bottom cover 5 is provided with a toggle bump 51 for facilitating disassembly and assembly of the oral irrigator bottom cover 5. In the specific implementation process, the toggle bump 51 and the oral irrigator bottom cover 5 are an integrally formed structure, and the oral irrigator bottom cover 5 is snap-fitted with the oral irrigator main shell 4.

As shown in FIG. 3 and FIG. 9, the oral irrigator main shell 4 is provided with a water inlet 43 communicated with the second accommodating cavity 42, the water inlet 43 is provided with a water tank door 11 for closing the water inlet 43, and the water tank door 11 is sleeved and connected with a second waterproof ring 12. In the specific implementation process, one end of the water tank door 11 is hinged to the oral irrigator main shell 4.

As shown in FIG. 3 to FIG. 7, the locking assembly 8 includes an installation seat 81, a locking element 82 and a release button 83, one end of the oral irrigator nozzle 1 is configured to pass through the oral irrigator upper cover 2 and is embedded in the installation seat 81, the release button 83 is embedded in the oral irrigator upper cover 2, the locking element 82 is configured to pass through the installation seat 81 and snap with the oral irrigator nozzle 1, and the release button 83 is configured to drive the locking element 82 to move horizontally, so as to separate the locking element 82 from the oral irrigator nozzle 1. In the specific implementation process, the oral irrigator nozzle 1 is provided with a nozzle slot provided in an annular shape, the locking element 82 is provided with a locking part 822 snap-fitted with the nozzle slot, and the locking part 822 is provided with a locking slope 8221 that allows the locking part 822 to smoothly enter and exit the nozzle slot. One end of the locking element 82 is provided with a pushing part 823, and the release button 83 is provided with an extrusion slope 831 adapted to the pushing part 823. An end surface of the pushing part 823 close to the extrusion slope 831 is provided as a cambered surface. The installation seat 81 is fixedly installed at the water outlet end 732 of the oral irrigator water pump 73. In order to prevent water from flowing back into the oral irrigator water pump 73, the water outlet end 732 of the oral irrigator water pump 73 is provided with a one-way valve.

As shown in FIG. 3 to FIG. 5, the locking member 82 is provided with a locking column 821, the locking column 821 is sleeved and connected with a locking spring 84, and one end of the locking spring 84 is abutted against the installation seat 81. In the specific implementation process, the locking column 821 and the locking element 82 are an integrally formed structure, the installation seat 81 is provided with a flat abutment surface 811, and one end of the locking spring 84 is abutted against the abutment surface 811.

As shown in FIG. 3 to FIG. 5, the oral irrigator upper cover 2 is detachably connected with an installation platform 85, a reset spring 86 is provided in the installation platform 85, and the reset spring 86 is abutted against the release button 83. In the specific implementation process, the installation platform 85 and the oral irrigator upper cover 2 are fixedly connected by screws, and the oral irrigator inner shell 3 and the oral irrigator main shell 4 are fixedly connected by screws.

In the specific implementation process, by pressing the release button 83, squeezing the reset spring 86, and driving the extrusion slope 831 to squeeze the pushing part 823, the pushing part 823 drives the locking element 82 to perform a horizontal movement, and squeeze the locking spring 84 to separate the locking part 822 from the nozzle slot, so as to facilitate the removal of the oral irrigator nozzle 1. When the oral irrigator nozzle 1 is snapped and installed, the release button 83 returns to its original position under the elastic force of the reset spring 86, the locking spring 84 squeezes the locking element 82 to enable the locking element 82 to move horizontally, so that the locking part 822 enters the nozzle slot, and then smoothly locks the oral irrigator nozzle 1.

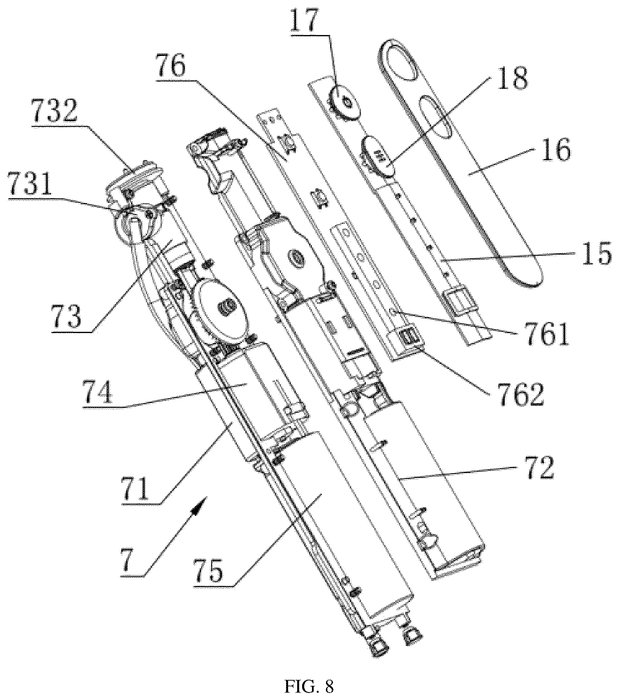

As shown in FIG. 3 and FIG. 8, the water pump mechanism 7 includes a first installation rack 71 and a second installation rack 72 detachably connected to the first installation rack 71. An oral irrigator water pump 73, an oral irrigator motor 74 and a battery 75 are provided between the first installation rack 71 and the second installation rack 72, a water inlet end 731 of the oral irrigator water pump 73 is connected to the charging base 6 by a pipeline, a water outlet end 732 of the oral irrigator water pump 73 is communicated with the oral irrigator nozzle 1, and the oral irrigator motor 74 is configured to drive the oral irrigator water pump 73 to perform pumping work. In the specific implementation process, the first installation rack 71 and the second installation rack 72 are fixedly connected by screws.

As shown in FIG. 3 and FIG. 8, a control panel 76 for controlling working status of the oral irrigator is provided on the second installation rack 72, the control panel 76 is provided with a display light 761 and a digital display tube 762, and the display light 761 is configured for displaying a working gear of the oral irrigator. In the specific implementation process, four display lights 761 are provided, which are configured for displaying a soft mode, a clean mode, a burst mode and a custom mode of the oral irrigator. The oral irrigator main shell 4 is provided with a body rubber covering 15 and a decorative cover 16. The body rubber covering 15 is provided with a first button 17 and a second button 18. The first button 17 is configured for controlling the on/off state of the oral irrigator, and the second button 18 is configured for controlling the working gear of the oral irrigator. The control panel 76 is provided at the second installation rack 72 by screws. The body rubber covering 15 and the decorative cover 16 are both made of transparent materials.

Working principle: by providing the first accommodating cavity 41 and the second accommodating cavity 42 in the oral irrigator main shell 4 in sequence, the first accommodating cavity 41 is provided with the water pump mechanism 7, and the second accommodating cavity 42 is configured for storing water, thereby providing an oral irrigator easily disassembled and assembled, and facilitating disassembly and assembly of the oral irrigator. Since the oral irrigator main shell 4 and the water tank shell are an integrally formed structure, the manufacturing cost of the oral irrigator is reduced.

Obviously, the above-mentioned embodiments are only examples for clear explanation and are not intended to limit the implementation. For those skilled in the art, other different forms of changes or modifications can be made based on the above description. An exhaustive list of all implementations is neither necessary nor possible. The obvious changes or modifications derived therefrom are still within the scope of the present application.

What is claimed is:

1. An oral irrigator easily disassembled and assembled, comprising:
an oral irrigator nozzle;
an oral irrigator upper cover;
an oral irrigator inner shell, wherein the oral irrigator inner shell is provided with a locking assembly for locking and installing the oral irrigator nozzle;
an oral irrigator main shell, wherein the oral irrigator main shell is provided with a first accommodating cavity and a second accommodating cavity in sequence, and the first accommodating cavity and the second accommodating cavity are separated by a charging base; a water pump mechanism is provided in the first accommodating cavity, the second accommodating cavity is configured to store water, and the water pump mechanism is configured to extract water in the second accommodating cavity and spray extracted water from the oral irrigator nozzle to clean teeth; and
an oral irrigator bottom cover, wherein one end of the oral irrigator main shell is provided with the oral irrigator inner shell and the oral irrigator upper cover in sequence, and the other end of the oral irrigator main shell is detachably connected to the oral irrigator bottom cover.

2. The oral irrigator easily disassembled and assembled of claim 1, wherein a storage rack is provided in the charging base, and the storage rack is provided with a storage slot, and the storage slot is configured to snap and store the oral irrigator nozzle.

3. The oral irrigator easily disassembled and assembled of claim 1, wherein the oral irrigator bottom cover is sleeved with a first waterproof ring.

4. The oral irrigator easily disassembled and assembled of claim 1, wherein the oral irrigator bottom cover is provided with a toggle bump, and the toggle bump is configured to facilitate disassembly and assembly of the oral irrigator bottom cover.

5. The oral irrigator easily disassembled and assembled of claim 1, wherein the oral irrigator main shell is provided with a water inlet communicated with the second accommodating cavity, the water inlet is provided with a water tank door for closing the water inlet, and the water tank door is sleeved and connected with a second waterproof ring.

6. The oral irrigator easily disassembled and assembled of claim 1, wherein the locking assembly comprises an installation seat, a locking element and a release button, one end of the oral irrigator nozzle is configured to pass through the oral irrigator upper cover and is embedded in the installation seat, the release button is embedded in the oral irrigator upper cover, the locking element is configured to pass through the installation seat and snap with the oral irrigator nozzle, and the release button is configured to drive the locking element to move horizontally, so as to separate the locking element from the oral irrigator nozzle.

7. The oral irrigator easily disassembled and assembled of claim 6, wherein the locking member is provided with a locking column, the locking column is sleeved and connected with a locking spring, and one end of the locking spring is abutted against the installation seat.

8. The oral irrigator easily disassembled and assembled of claim 6, wherein the oral irrigator upper cover is detachably connected with an installation platform, a reset spring is provided in the installation platform, and the reset spring is abutted against the release button.

9. The oral irrigator easily disassembled and assembled of claim 1, wherein the water pump mechanism comprises a first installation rack and a second installation rack detachably connected to the first installation rack, an oral irrigator water pump, an oral irrigator motor and a battery are provided between the first installation rack and the second installation rack, a water inlet end of the oral irrigator water pump is connected to the charging base by a pipeline, a water outlet end of the oral irrigator water pump is communicated with the oral irrigator nozzle, and the oral irrigator motor is configured to drive the oral irrigator water pump to perform pumping work.

10. The oral irrigator easily disassembled and assembled of claim 9, wherein a control panel for controlling a working status of the oral irrigator is provided on the second installation rack, the control panel is provided with a display light and a digital display tube, and the display light is configured to display a working gear of the oral irrigator.
